(19) United States
(12) Patent Application Publication
(10) Pub. No.: US 2007/0182194 A1
(43) Pub. Date: Aug. 9, 2007

(54) Tailgate ladder

(76) Inventors: Chad Wood, Salida, CO (US); Jerry L. Wood, Canon City, CO (US)

Correspondence Address: Chad Wood, 6680 County Rd. 156, Salida, CO, 61201, US

(21) Appl. No.: 11/312,221

(22) Filed: Dec. 21, 2005

(51) Int. Cl. B62D 25/00

(52) U.S. Cl. 296/62

(57) ABSTRACT

A tailgate ladder attached to a pickup truck tailgate. The ladder is attached to one of a pair of pivot plates with a hinge assembly that allows it to be raised to a horizontal position. At the horizontal position, the ladder is then pivoted over the tailgate and secured with a bracket for storage.

### BACKGROUND OF THE INVENTION

1. Field of the Invention

The present invention relates to pickup truck tailgate ladder systems. More specifically, to a ladder system installed on the inside of a pickup tailgate that travels, when the tailgate is up, on the inside of the tailgate and then, when needed by users, is swung around on pivoting plates and lowered to the ground on hinged apparatus to facilitate user access from the ground to the back of pickup trucks.

2. Description of Related Art

Pickup trucks are prized by their owners for their ability to carry loads, but often the bed of the truck is too high for comfortable and easy access. Access improvements have included tailgate-mounted steps, as in Pat. Nos. 6,966,597, 6,764,123, 6,270,139, and 5,941,342. The step improvements are large and bulky, though many are mounted on the inside of the tailgate. The step and ladder improvements range from folding ladders mounted inside or outside the tailgate, as in U.S. Pat. Nos. 6,941,478, 6,116,378, and 6,422,342, to a single step apparatus, as in U.S. Pat. Nos. 6,942,272, 6,905,158, and 5,732,996.

This invention provides an easy to install system that avoids the bulkiness of folding systems and is more substantial than the single step systems in that it provides more stability between the ground and the tailgate.

### SUMMARY OF THE INVENTION

The object Of the invention is to provide a ladder apparatus that is attachable to the inside of a pickup truck tailgate. The apparatus is comprised of a solid ladder of sufficient length to reach from the installation point to the ground.

The further object is that the ladder be stowable on the inside of the tailgate when the gate is closed. The apparatus if further comprised of a hinged and pivoting system that allows the ladder to be raised and swung onto the tailgate for storage.

It is also the further object that the ladder is of solid stability, allowing access to the bed of the truck to smaller or less physically agile people. By extending the entire distance from the tailgate to the ground, the ladder provides multi-rung access to the pickup bed.

These together make this invention is an installable, stowable, and stable tailgate ladder system.

### BRIEF DESCRIPTION OF DRAWINGS

FIG. 1 is a view of the ladder extended to the ground.

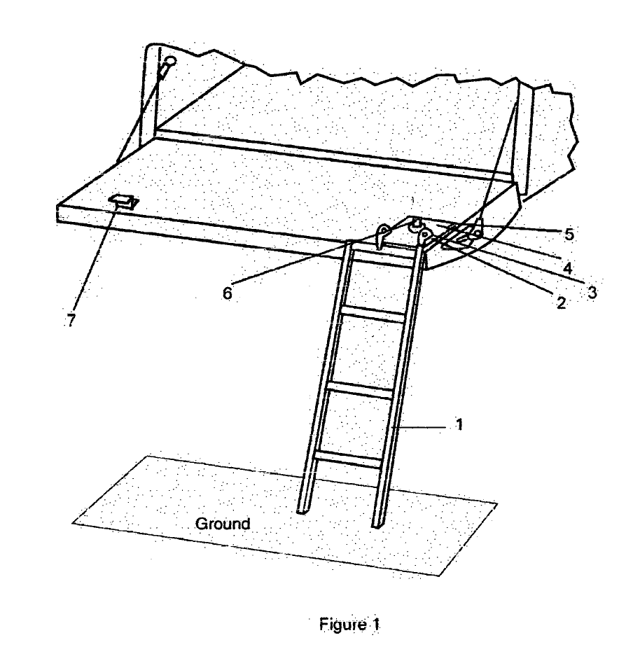

FIG. 2 is a view of the ladder in the stowed position.

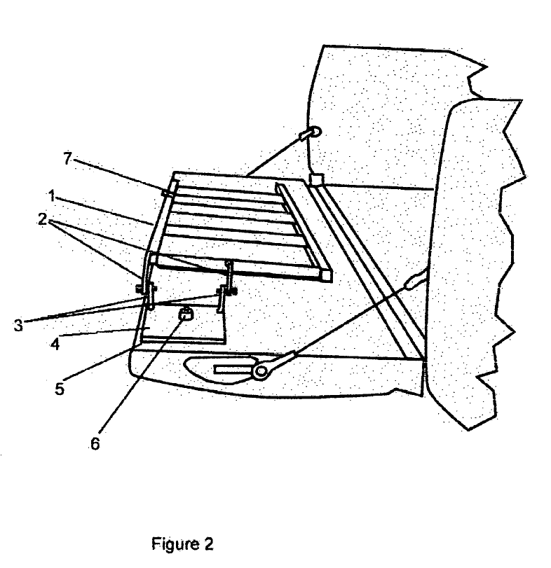

### DETAILED DESCRIPTION

The tailgate ladder, in its preferred embodiment, is comprised of a ladder, two pivot plates, and a security bracket for storage.

The ladder 1 is a single piece comprised of two side supports and four rungs. The top part of the ladder, where it attaches to the tailgate piece, is comprised of two flat half-hinges 2 with holes. One ladder-side hinge component is part of the right side of the vertical ladder support. The second is welded to the top rung the distance necessary to match the half-hinges 3 on the pivot plate 4, for example, six inches.

The two hinge elements on the ladder 2 attach to the hinge elements 3 on the top pivot plate 4. The top pivot plate is comprised of a flat square plate with a hole in the middle and two hinge elements 3 with holes on the top face. The hinge elements of the top pivot plate match the hinge elements on the ladder 2 and the two are attached pins. This allows the ladder to swing up and down. Up to the level of the tailgate so it can be pivoted and stored; and down to the ground, making it adaptable to uneven ground conditions and variations in the bed height of different trucks.

The top pivot plate 4 is attached to the bottom plate 5 using a threaded bolt and nut 6. The bottom pivot plate is comprised of a square plate with a threaded bolt 6 in the middle and four counter sink holes at each of the four corners of the plate. The bottom plate is attached to the tailgate using screws through the four holes at each corner. The hole in the center of the top pivot plate is then placed through the bolt on the bottom plate and the two are secured together with a nut, but not tightly. The top plate 4 pivots around the bolt 6.

To store the ladder, the ladder 1 is lifted from the bottom so that it swings upward on the hinges (2 and 3). Once the bottom of the ladder is at the same height as the tailgate, it is pivoted in a clockwise direction 90°. The top plate 4 turns on the bolt 6 with the ladder while the bottom plate 5 remains fixed to the tailgate. The ladder then slides into the z bracket 7 for secure storage when the tailgate is raised and locked.

What is claimed is:

1. A truck tailgate ladder assembly comprising:
a. a four rung ladder with two half hinges at the top rung,
b. a top pivot plate with two half hinges matching those on the top rung that is attached to the ladder with two pins and attached to the bottom plate through a hole in the center,
c. a bottom plate with a threaded bolt in the center that is attached the inside of the tailgate by some method that may include screws and is attached to the top pivot plate through the use of the center bolt secured with a nut,
d. a z bracket to hold the ladder secure in the stored position.

2. A ladder device as in claim 1 wherein the device comprises:
a. a solid ladder of sufficient length that it reaches the ground from the back of the extended tailgate,
b. has two half hinges where one hinge is located at the top of one support and the other is located a sufficient distance that it matches the hinges on the top pivot plate.

3. A top pivot plate device as in claim 1 wherein the object comprises:
a. a square plate with a hole in the center,
b. two half hinges that match the hinges on the ladder,
c. attached to the ladder with locking pins that do not inhibit hinge motion.

4. A bottom pivot plate device as in claim 1 wherein the object comprises:
a. a square plate with a threaded bolt in the center,
b. four counter-sink holes at each of the four corners of the plate,
c. attached to the tailgate using screws or other attaching methods and attached to the top plate by way of the threaded bolt secured with a nut to the top plate but without inhibiting the pivoting motion.

5. A z bracket device as in claim 1 wherein the said object comprised of a z bracket where one leg of the z is attached to the tailgate at a distance placing it near the end of the ladder when the ladder is raised and pivoted into the stowed position.
